(19) United States
(12) Patent Application Publication
(10) Pub. No.: US 2026/0359584 A1
(43) Pub. Date: Nov. 12, 2026

(54) DEVICE VERIFICATION

(71) Applicant: Stage Lighting Patents, LLC, Windermere, FL (US)

(72) Inventor: Huntly Gordon Christie, Windermere, FL (US)

(73) Assignee: Stage Lighting Patents, LLC, Windermere, FL (US)

(21) Appl. No.: 19/671,554

(22) Filed: May 8, 2026

Related U.S. Application Data
(60) Provisional application No. 63/802,016, filed on May 8, 2025.

(51) Int. Cl. G06K 7/00; G06F 21/73

(52) U.S. Cl. CPC G06K 7/0008; G06F 21/73

(57) ABSTRACT

An example of an apparatus is provided. The apparatus includes a scanner to detect a plurality of assets. Each asset of the plurality of assets has an identifier to be read by the scanner. The apparatus also includes a memory storage unit to maintain a database to store the identifier of each asset read by the scanner and to store the identifier in the database. Furthermore, the apparatus includes a reader to read an identification marking on an asset selected from the plurality of assets. In addition, the apparatus includes a verification engine in communication with the memory storage unit and the reader. The verification engine determines whether the identifier for the asset associated with the identification marking is in the database. The apparatus also includes an alert system to alert a user when the identifier is missing from the database.

### CROSS-REFERENCE TO RELATED APPLICATION

This application claims priority to U.S. Provisional Patent Application No. 63/802,016, filed May 8, 2025, which is incorporated by reference in its entirety.

### BACKGROUND

Businesses may own assets that are loaned, rented, or leased out for use. The types of assets that may be handled in this manner are not limited and may include a wide variety of assets, such as specialized equipment for stages, tools, sports equipment, etc. The benefits of having another entity own and manage assets are known. For example, the users of the asset may focus on using the asset so that they do not focus on maintaining the asset, especially if only a few of the assets are used at a given time. Furthermore, it allows the usage of an asset to be increased as the user may only use the asset for a small portion of the user’s operation.

As assets are received back from a loan period, the asset may be scanned automatically as they enter a storage facility, such as a warehouse or storeroom, upon return. For example, each asset may include an identifier, such as a radio-frequency identification tag, barcode, or other readable identifier. In some examples, the identifier may be read as an asset is moved into a storage facility and automatically checked-in upon scanning of the identifier. Assets may also be subject to a quality assurance step to determine if the asset may be redeployed or whether the asset is to be replaced or repaired.

### SUMMARY

In accordance with an aspect of the invention, there is provided an apparatus. The apparatus includes a scanner to detect a plurality of assets. Each asset of the plurality of assets has an identifier to be read by the scanner. The apparatus also includes a memory storage unit to maintain a database. The database is to store the identifier of each asset read by the scanner and to store the identifier in the database. In addition, the apparatus includes a reader to read an identification marking on an asset selected from the plurality of assets. Furthermore, the apparatus includes a verification engine in communication with the memory storage unit and the reader. The verification engine determines whether the identifier for the asset associated with the identification marking is in the database. The apparatus also includes an alert system to alert a user if the identifier is missing from the database.

The scanner may be a radio-frequency identification scanner. The apparatus may also include a tagging unit to re-apply a radio-frequency identification to the asset. The reader may be a directional scanner to target the identification marking on the asset. The reader may be a barcode scanner.

In addition, the apparatus may include a communications interface to transmit an alert to an external device. The communications interface may receive updates to the database from the scanner. The apparatus may also include a display to output the alert.

### BRIEF DESCRIPTION OF THE DRAWINGS

Reference will now be made, by way of example only, to the accompanying drawings in which:

FIG. 1 is a block diagram of an example apparatus to process assets loaned, rented, or leased to another party;

FIG. 2 is a block diagram of another example apparatus to process assets loaned, rented, or leased to another party;

FIG. 3 is a representation of a building deploying the apparatus shown in FIG. 2 in an example configuration;

FIG. 4 is a block diagram of another example apparatus to process assets loaned, rented, or leased to another party;

FIG. 5 is a block diagram of another example apparatus to process assets loaned, rented, or leased to another party; and

FIG. 6 is a flowchart of an example method of processing assets loaned, rented, or leased to another party.

### DETAILED DESCRIPTION

It is common for assets used for commercial purposes to be owned by a party that is different from the one using the asset. There may be a number of reasons to manage assets in this manner. For example, there may be financial benefits, such as tax benefits. Furthermore, for certain types of assets where continuous use is not common or when the assets are used for a discrete period of time, such as for a specific project, the owner of the asset may achieve better utilization of the asset by providing the asset to multiple parties. Another example of a reason for renting or leasing an asset owned by another party may be due to the expertise of the party owning the asset to maintain the asset. For example, the skill set of a party using the asset may not include the skills for maintaining the assets in a good state of repair.

As an example, stage lighting equipment used for performances, such as plays, concerts, or lectures to provide visual enhancements are often owned and managed by a party that is different from the performers. In most cases, the assets are not owned by a venue as different stages may use different equipment to provide specific looks or visuals. Additional effects such as pyrotechnic displays and fog machines may also be used. Some of the equipment used to provide the visual effects may be positioned above the stage to improve the generated effect. For example, a light or laser source may be positioned above the stage so that light may be directed at the stage during a performance from above to achieve an appropriate lighting effect. Furthermore, such equipment may be supported around the stage with various trusses which may be provided by other parties.

As another example, rental sporting equipment may be provided to athletes for use. In this example, a sporting venue such as a golf course, ski resort, or watersport rental shop may offer equipment for use by an athlete or participant. The equipment may include golf clubs, skis, watercraft and associated personal protective equipment. To protect the assets, the owners or operators of the rental shop track each piece of equipment as it leaves the shop and cross references the returning equipment against details. Tracking the assets generally involves recording each change in status of an asset, such as when carriage of the asset changes from the owner to the renter, or when the asset leaves or returns to a storage facility. The data recorded may then be used to determine the costs or usage of the asset.

A common way to track assets is to scan the assets at various points as the asset moves throughout the rental process as well as other points, such as when the asset is checked-out of a storage facility, checked-in to a storage facility upon return, or sent off for repairs. In the present examples, each asset may include multiple identifiers and identification markings, such as a radio-frequency identification tag, a barcode, or other readable identifiers. The use of multiple identifiers provides a redundant way to identify an asset. However, it is to be appreciated by a person of skill with the benefit of this description that the unique identifiers on each asset may become defective over time through normal wear and tear. For example, a radio-frequency identification tag may be knocked off the asset or the antenna otherwise damaged from rubbing against other objects. If one identifier of the asset is damaged or removed, the remaining identifier may still be used to identify the asset. In another example, different identifiers may be used at different points of the process. For example, a radio-frequency scanner may be used to scan multiple assets at once and a later review process or quality assurance step may individually read a barcode for each asset subject to review.

An apparatus and method of processing assets that are loaned, rented, or leased to others and an apparatus to carry out the method are provided. The apparatus and method are to confirm the operational status of a unique identifier during a quality assurance step. In the present examples, each asset includes a unique identifier to be detected during a check-in phase and a different identification mark to be read during a quality assurance step. Part of the quality assurance step is to determine whether the unique identifier was previously read during the check-in phase.

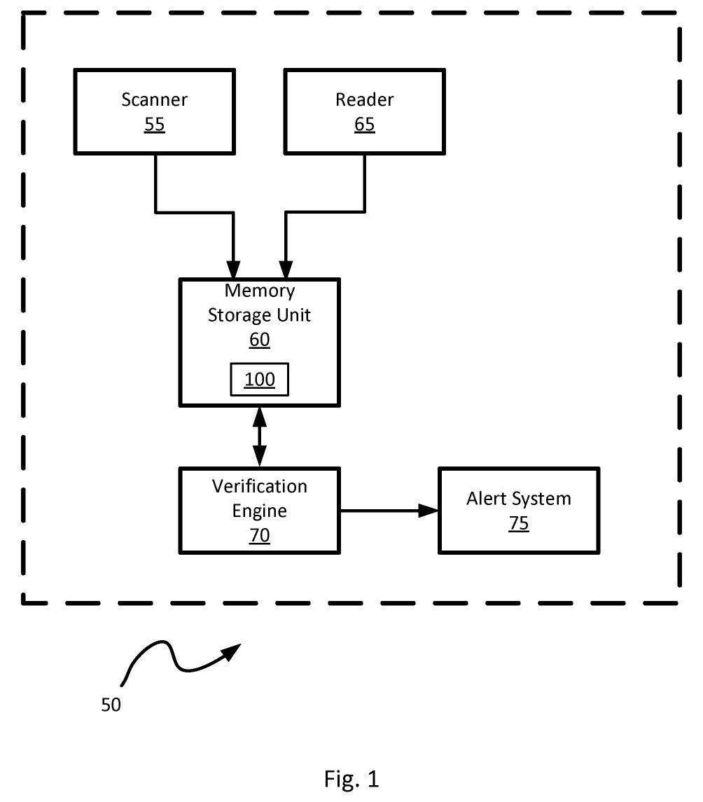

Referring to FIG. 1, an apparatus to process assets loaned, rented, or leased to other parties is generally shown at 50. The apparatus 50 may include additional components, such as various devices and interfaces to receive input and output devices to interact with a user or an administrator with access to control the apparatus 50. In the present example, the apparatus 50 includes a scanner 55, a memory storage unit 60, a reader 65, a verification engine 70, and an alert system 75.

The scanner 55 is configured to detect unique identifiers. In the present example, the scanner 55 may be a radio-frequency identification scanner configured to read serial numbers from a radio-frequency identification tag affixed to an asset. Since the radio-frequency identification scanner is generally non-directional, the scanner 55 may be used to detect radio-frequency identification tags from multiple assets within range. Since each asset includes a unique identifier that may be scanned and read by the scanner 55, the scanner 55 may be placed in a location where assets pass through to track movement of the assets. In particular, the scanner 55 may be placed at a gate to record assets passing therethrough as part of a check-in process or check-out process.

In the present example, the memory storage unit 60 receives data from the scanner 55. In particular, the scanner 55 saves the unique identifiers detected into a database 100 for the assets, which is maintained in the memory storage unit 60. Accordingly, as the scanner 55 detects a unique identifier of an asset, the unique identifier is stored in the database 100. In examples where a data record associated with the asset having the unique identifier is already in the database 100, the detection by the scanner 55 may be logged or the data record may be updated. In examples where the database 100 does not have a data record associated with the asset having the unique identifier, a data record may be generated.

The information stored in the database 100 is not limited to the data received from the scanner. In the present example, the database 100 may store records associated with an asset. Accordingly, the database 100 may store information associated with each of the plurality of assets. In the present examples, the data stored in each record may include the unique identifiers and identification marks that are associated with each asset. Each record in the database 100 may further include a description and specifications linked to each asset, such as a status indicator, a type of asset, a unique identifier of the asset, model number, dimensions, size, etc. The status indicator may indicate a status of the asset, such as the location and the condition of the asset. In particular, the status indicator may indicate the asset is checked-out, which means that the asset is currently on loan, rented out, or leased out. The status indicator may also indicate that the asset is checked-in, undergoing service, or being repaired. Accordingly, it is to be appreciated by a person of skill that the apparatus 50 may be used to change the status of the asset. While the memory storage unit 60 may store the status of each asset locally on the apparatus 50, some examples may store the status indicator at a central server (not shown). In such examples, the apparatus 50 may be used to record a status change of an asset, to be updated at a later time when the apparatus 50 can communicate with the central server where the status indicator is stored.

In the present example, the memory storage unit 60 is not particularly limited and may include a non-transitory machine-readable storage medium that may be, for example, an electronic, magnetic, optical, or other physical storage device. In the present example, the memory storage unit 60 is a persistent memory that may also store an operating system that is executable by a processor to provide general functionality to the apparatus 50. For example, the operating system may provide functionality to additional applications operating on the apparatus 50. The memory storage unit 60 may additionally store instructions to operate the apparatus 50 to communicate with other components and peripheral devices of the apparatus 50, such as additional reader devices, communication interfaces, display devices, etc.

The reader 65 is configured to read an identification marking disposed on a specific asset. In particular, if the scanner 55 scans a plurality of assets as part of a check-in process, the reader 65 may be used to read the identification marking on one of those assets. In the present example, the reader 65 may be a directional scanner, such as an optical scanner. The optical scanner may be a fixed laser scanner to read a unique identifier, such as a barcode or QR code. In particular, the reader 65 may be used during a quality assurance step where individual assets are inspected, such as after being returned from a rental contract.

The verification engine 70 is to confirm that the unique identifier associated with a specific asset has been detected by the scanner 55 and the reader 65. In the present example, the verification engine 70 is in communication with the memory storage unit 60 and can access the database 100. Upon reading the identification marking by the reader 65, the verification engine 70 reviews the data record of the asset associated with the identification marking to determine whether the unique identifier was detected by the scanner 55 based on data stored in database 100. If the scanner 55 detected the unique identifier, the verification engine 70 takes no further action or generates a confirmation message that the asset unique identifier has been confirmed as operational. In the case where the scanner 55 fails to detect the unique identifier, the verification engine 70 does not generate the confirmation message. Instead, the verification engine 70 activates the alert system 75.

The alert system 75 is to generate an alert for a user of the apparatus 50. The alert informs the user that the unique identifier is missing from the database 100 or the database 100 did not record a detection of the identifier of the asset by the scanner 55. This informs the user that further investigation into the asset is to be carried out to determine the cause of the detection failure by the scanner 55. The cause of a failed detection is not limited and may include the asset not coming within range of the scanner 55 during the check-in process or a failed radio-frequency identification tag. The manner by which the alert system 75 generates the alert is not particularly limited. In the present example, the apparatus 50 may include a display (not shown) to output the alert. In other examples, the alert may include a light or LED, or an audio cue.

In the case where the radio-frequency identification tag is found to be defective, a new radio-frequency identification tag may be applied to the asset and the database 100 updated. In some examples, the apparatus 50 may also include a tagging unit (not shown) to re-apply a radio-frequency identification tag to the asset. It is to be appreciated by a person of skill with the benefit of this description that the apparatus 50 may be used to verify the identifiers on a specific asset during a quality assurance process so that the asset may be rented out again. If an error in the identifiers of a specific asset is detected, appropriate repairs may be made prior to the next deployment of the asset.

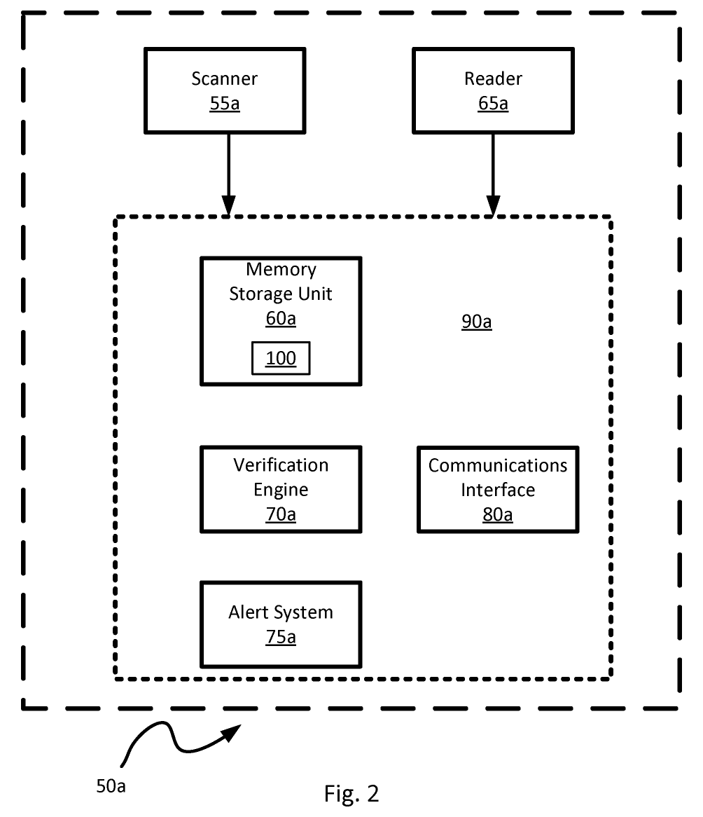

Referring to FIG. 2, another example of an apparatus 50a to process assets loaned, rented, or leased to another party is generally shown. Like components of the apparatus 50a bear like reference to their counterparts in the apparatus 50, except followed by the suffix “a”. The apparatus 50a includes a scanner 55a, a reader 65a, and an inventory management system 90a.

In the present example, the inventory management system 90a of the apparatus 50a includes a communications interface 80a to communicate with an external device. The communications interface 80a is to transmit an alert message generated by the alert system 75a to the external device. The external device is not particularly limited and may be a central server storing another database that includes a status indicator for each of the assets.

In the present example, the inventory management system 90a may execute instructions stored on the memory storage unit 60a to manage the database 100 based on inputs received from the scanner 55a. In addition, the inventory management system 90a may implement a verification engine 70a and the alerts system 75a. It is to be appreciated by a person of skill with the benefit of this description that the inventory management system 90a is not limited and may not be a single physical computer system and may include a collection of processors operated on separate machines, such as from a software as a service provider or in a virtual cloud server.

The communications interface 80a is not particularly limited and may serve other purposes for the inventory management system 90a in general. For example, the communications interface 80a may be used to send and receive data to and from external sources. For example, the communications interface 80a may receive updates to the database 100 when there is a change of the unique identifiers associated with an asset. In further examples, the communications interface 80a may receive data from the scanner 55a or other scanners that detect unique identifiers to update the database 100.

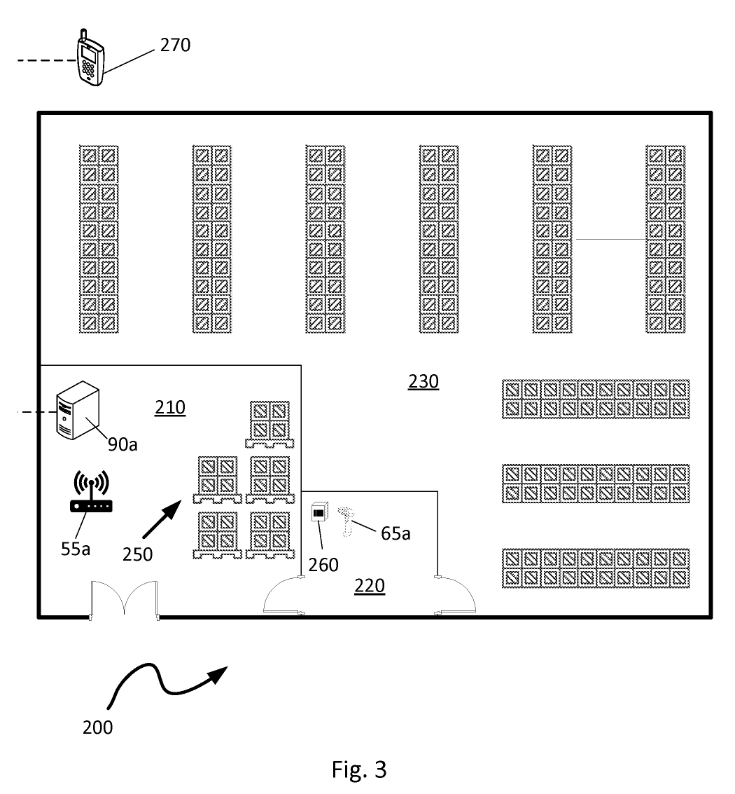

Referring to FIG. 3, an example of the apparatus 50a deployed in a building 200 is shown. In particular, the building 200 is a storage facility for assets 260 that are loaned, rented, or leased to other parties. In the present example, the building 200 includes a loading area 210, a quality assurance area 220, and a storage area 230.

The loading area 210 is the main entry and exit point for the assets 260. In general, the loading area 210 generally includes a loading dock where trucks or other transportation means can pick up or drop off assets. The assets 260 are generally stored in boxes 250 for shipping and may be further bundled onto pallets or larger cases to facilitate the loading and unloading onto trucks or other transportation means. The scanner 55a of the apparatus 50a is disposed in the loading area to detect radio-frequency identification tags from each asset 260 in the loading area 210. During operation, as shipments of assets 260 in boxes 250 are received in the loading area 210, the scanner 55a scans the boxes 250 to detect unique identifiers of assets 260 in the boxes 250. The scanner 55a provides a list of detected assets 260 to the inventory management system 90a. The detected assets 260 may be stored in the database 100 of the inventory management system 90a for later use.

Prior to returning the assets to the storage area 230, each of the assets 260 is to be inspected to pass a quality assurance check. In the present example, the quality assurance check is carried out in the quality assurance area 220. It is to be appreciated by a person of skill with the benefit of this description that the quality assurance process is not limited to a specific area of the building 200 and may be carried out elsewhere. For example, some buildings may not have a separate designated quality assurance area or the quality assurance may be carried out in the loading area 210 or the storage area 230. However, having a separate quality assurance area 220 improves general organization of the process and reduces the likelihood of mixing assets 260 that have yet to go through the process with assets 260 that have been processed and are ready for storage.

Upon return of an asset 260, the asset 260 undergoes a quality assurance inspection prior to storage and/or subsequent rental. This inspection is to verify that the asset 260 remains in proper working condition, free from damage, defects, or excessive wear that could compromise its functionality or safety for the next user. By conducting a thorough quality assurance check between each rental cycle, the assets are maintained in accordance with consistent product standards that have been predetermined. In addition, the quality assurance process reduces potential liability associated with distributing faulty or unsafe equipment, and preserves the longevity of its rental inventory. Items that do not pass inspection shall be flagged for repair, refurbishment, or removal from the active rental pool, as appropriate. In addition, some assets 260 may be part of a regular preventative maintenance schedule and the quality assurance process may be used to identify when each of these assets 260 are due for their regularly scheduled maintenance.

During the quality assurance check, each asset 260 is to be scanned with a reader 65a as part of the quality assurance process such that any notes about the asset 260 can be entered more efficiently into the system. In the present example, the reader 65a is configured to read an identification marking disposed on the asset 260. The identification marking on each of the assets 260 is unique and is to be read one at a time while the specific asset 260 is being inspected. The manner by which the reader 65a reads the identification marking is not particularly limited as long as the reader 65a can read the identifier without interference from nearby assets 260. In one example, the reader 65a may be a handheld directional scanner, such as an optical scanner. The optical scanner may be a fixed laser scanner to read a unique identifier, such as a barcode or QR code when directed at the asset 260. Accordingly, the reader 65a would only read the identification marking from the targeted asset 260. In other examples, the reader 65a can be a near field communication device that will read a chip disposed on the asset 260. In such examples, the power of the transmitter and sensitivity of the receiver of the reader 65a is to be calibrated such that it does not excite the identifiers of nearby assets 260.

It is to be appreciated by a person of skill with the benefit of this description that the apparatus 50a provides an efficient way to process assets 260 as they are received from a rental return. The apparatus 50a rapidly scans in a plurality of assets 260 using the scanner 55a as part of the check-in process. In the present example, the scanner 55a is a radio-frequency scanner which may occasionally fail to read tags due to a variety of environmental and technical factors. For example, signal interference from nearby metals, liquids, or other electronic devices can weaken or distort the radio-frequency waves used to communicate between the scanner 55a and the tag on each asset 260, resulting in missed reads. Additionally, tag orientation, distance from the scanner 55a, and physical obstructions between the tag and the reader can all contribute to inconsistent detection. Tags that are damaged, improperly affixed, or nearing the end of their operational lifespan may also exhibit reduced responsiveness. In high-volume scanning environments, tag collision where multiple tags respond to a reader simultaneously can further degrade read accuracy.

While high-volume radio-frequency scanning environments offer significant efficiency gains in updating the status of each asset 260 to enable rapid, bulk processing of tagged assets with minimal manual intervention, individual quality assurance of each item is still performed by hand. This manual quality assurance procedure, in which each asset 260 is physically inspected for condition and maintenance cycle, provides a natural opportunity to double-check and verify the results produced by the high-volume scanning. Accordingly, by leveraging this routine manual process as a cross-reference against automated scan data, errors in the high-volume process can be identified and corrected. Any errors or discrepancies can be readily identified causing the alert system 75a to transmit a message to an external device 270. Upon receiving the message at the external device 270, the error can be corrected by appropriate measures, such as by updating the status of the asset 260 manually if the tag was simply missed, or replacing or repairing a tag that has become defective.

It is to be understood by a person of skill with the benefit of the present example that variations are possible. For example, the present example places the inventory management system 90a in the loading area 210. It is to be understood that the location of the inventory management system 90a is not particularly limited and may be located anywhere that it can communicate with the scanner 55a and the reader 65a. For example, the inventory management system 90a may be placed in the quality assurance area 220, the storage area 230 or another room. Furthermore, as previously noted, the inventory management system 90a may not be in the building and operated over the internet or as a cloud service.

Another example of a possible variation is that although the external device 270 is shown to be a portable electronic device away from the building 200, this example illustrates that the alert may be transmitted to another person, such as a supervisor to investigate the cause of the error. In other examples, the external device 270 may be in the building 200 or may be a fixed device, such as a display in the quality assurance area 220. In further examples, the external device 270 may be the same device as the reader 65a such that the person carrying out the quality assurance is instantly notified of the error and can take corrective action if possible.

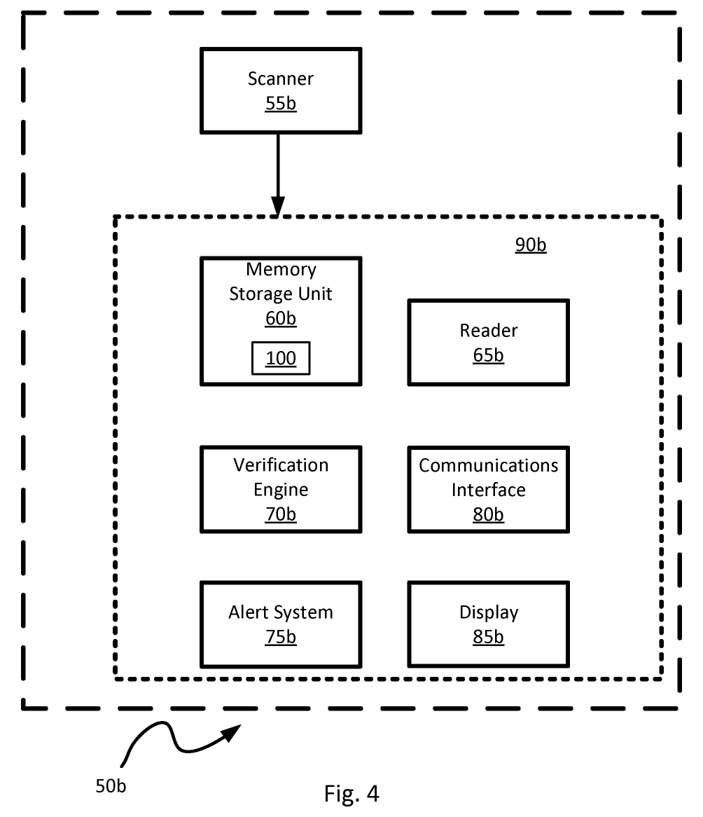

Referring to FIG. 4, another example of an apparatus 50b to process assets loaned, rented, or leased to another party is generally shown. Like components of the apparatus 50b bear like reference to their counterparts in the apparatus 50b, except followed by the suffix “b”. The apparatus 50b includes a scanner 55b and an inventory management system 90b.

In the present example, the inventory management system 90b may be a handheld unit that includes a memory storage unit 60b, a reader 65b, a verification engine 70b, an alert system 75b, a communications interface 80b, and a display 85b. In this example, the inventory management system 90b may communicate directly with the scanner via the communications interface 80b to receive a list of assets 260 scanned in the loading area 210. As each asset 260 goes through the quality assurance process, the inventory management system 90b can scan the identification marking on each asset 260. If the verification engine 70b determines that the scanner 55b failed to detect the unique identifier, an indicator can appear on the display 85b to alert the user. In some cases, the inventory management system 90b may also transmit an alert to an external device 270.

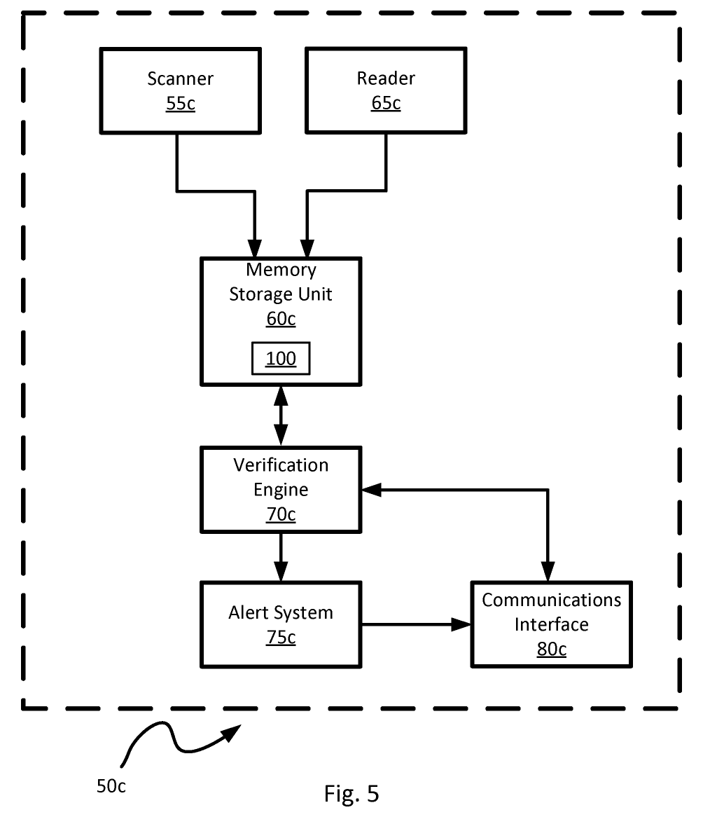

Referring to FIG. 5, another example of an apparatus 50c to process assets loaned, rented, or leased to another party is generally shown. Like components of the apparatus 50c bear like reference to their counterparts in the apparatus 50, except followed by the suffix “c”. The apparatus 50c includes a scanner 55c, a memory storage unit 60c, a reader 65c, a verification engine 70c, an alert system 75c, and a communications interface 80c.

In the present example, the apparatus 50c includes a communications interface 80c to communicate with an external device (not shown). In the present example, the communications interface 80c is to transmit an alert message generated by the alert system 75c to the external device. The external device is not particularly limited and may be a central server storing another database that includes a status indicator for each of the assets. Accordingly, the confirmation message may be used by the external device to update status indicators for the associated asset. In further examples, the communications interface 80c may also be used to receive data from an external device. For example, the communications interface 80c may receive updates to the database 100 when there is a change of the unique identifiers associated with an asset. In further examples, the communications interface 80c may receive data from the scanner 55c or other scanners that detect unique identifiers to update the database 100.

The manner by which the apparatus 50c communicates with the external device is not particularly limited. In the present example, the communications interface 80c may be connected to the external device via a network, such as the internet or a local network. Alternatively, the external device may be directly connected to the communications interface 80c via a wireless connection such as Bluetooth, WiFi, infrared, or other signals. In further examples, the communications interface 80c may receive data from a hardwired device, such as via a USB connection or a docking station, to transmit and receive data periodically, such as at the end of the day, during charging, or after a predetermined period of operation.

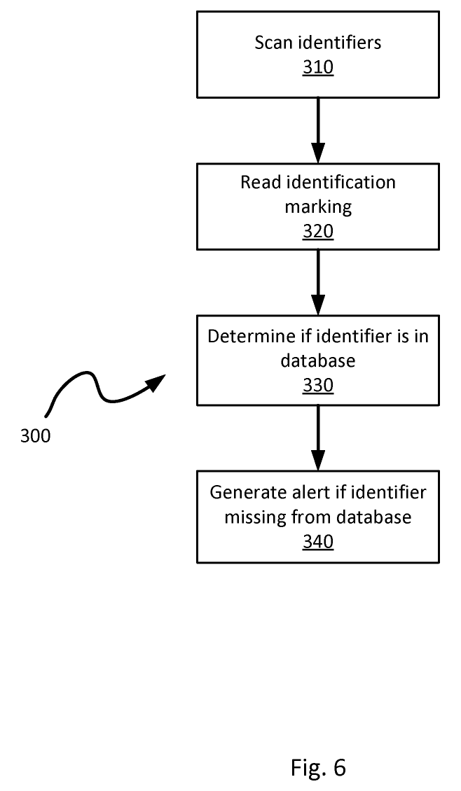

Referring to FIG. 6, a flowchart of a method of processing assets loaned, rented, or leased to another party is generally shown at 300. In order to assist in the explanation of method 300, it will be assumed that method 300 may be performed with any of the apparatus 50, 50a, 50b, or 50c. Indeed, the method 300 may be one way in which an apparatus may be configured. Furthermore, the following discussion of method 300 may lead to a further understanding of the apparatus and its various components. It is to be emphasized that method 300 may not be performed in the exact sequence as shown, and various blocks may be performed in parallel rather than in sequence, or in a different sequence altogether. In the following discussion, it will be assumed that the method 300 is carried out by the apparatus 50.

Block 310 involves using the scanner 55 to detect a plurality of unique identifiers from a plurality of assets. In particular, the scanner 55 scans an area where assets are received to be checked back into after a rental agreement has been completed. In the present example, the number of assets received may be large and the scanner 55 may be positioned in an area to conduct high-volume scanning of multiple assets with radio-frequency identification tags.

Block 320 involves using the reader 65 to read an identification marking of a specific asset selected from the plurality of assets. The reader 65 reads the unique identification marking during the quality assurance process. The identification marking may be different from the radio-frequency identification tag read by the scanner 55. For example, the reader 65 may be a handheld directional scanner, such as an optical scanner to read a barcode or QR code when directed at the identification marking of the asset. It is to be appreciated by a person of skill with the benefit of this description that the

At block 330, the verification engine 70 analyzes the database 100 to determine if the specific asset identified in block 320 was read by the scanner 55 during the operation of block 310. If the determination is made that the unique identifier associated with the asset read by the reader 65 is missing from the database 100 or indicated as not being read by the scanner 55, the alert system 75 will generate an alert to a user at block 340.

Various advantages will now become apparent to a person of skill with the benefit of this description. In particular, the apparatus 50 and the apparatus 50a provide a fast and efficient way to confirm the operational status of unique identifiers such as a radio-frequency identification tag and to detect when malfunctions occur.

It should be recognized that features and aspects of the various examples provided above may be combined into further examples that also fall within the scope of the present disclosure.

What is claimed is:

1. An apparatus comprising:
a scanner to detect a plurality of assets, wherein each asset of the plurality of assets has an identifier to be read by the scanner;
a memory storage unit to maintain a database, wherein the database is to store the identifier of each asset read by the scanner and to store the identifier in the database;
a reader to read an identification marking on an asset selected from the plurality of assets;
a verification engine in communication with the memory storage unit and the reader, wherein the verification engine determines whether the identifier for the asset associated with the identification marking is in the database; and
an alert system to alert a user when the identifier is missing from the database.

2. The apparatus of claim 1, wherein the scanner is a radio-frequency identification scanner.

3. The apparatus of claim 2, further comprising a tagging unit to re-apply a radio-frequency identification tag to the asset.

4. The apparatus of claim 1, wherein the reader is a directional scanner to target the identification marking on the asset.

5. The apparatus of claim 4, wherein the reader is a barcode scanner.

6. The apparatus of claim 1, further comprising a communications interface to transmit an alert to an external device.

7. The apparatus of claim 6, wherein the communications interface is to receive updates to the database from the scanner.

8. The apparatus of claim 1, further comprising a display to output the alert.

9. A method comprising:
reading identifiers from a plurality of assets with a scanner, wherein each asset of the plurality of assets has an identifier to be detected;
storing the identifier of the asset read by the scanner in a database maintained in a memory storage unit;
reading an identification marking on an asset selected from the plurality of assets;
determining whether the identifier for the asset associated with the identification marking is in the database; and
alerting a user when the identifier is missing from the database.

10. The method of claim 9, wherein reading identifiers comprises detecting a radio-frequency identification signal.

11. The method of claim 10, further comprising re-applying a radio-frequency identification tag to the asset when missing.

12. The method of claim 9, wherein reading the identification marking comprises targeting the identification marking with a directional scanner.

13. The method of claim 12, wherein targeting the identification marking comprises targeting a barcode.

14. The method of claim 9, further comprising transmitting the alert to an external device.

15. The method of claim 9, further comprising receiving updates to the database from a scanner.

16. A non-transitory machine-readable storage medium encoded with instructions executable by a processor, wherein the instructions are to direct the processor to:
read identifiers from a plurality of assets with a scanner, wherein each asset of the plurality of assets has an identifier to be detected;
store the identifier of the asset read by the scanner in a database maintained in a memory storage unit;
read an identification marking on an asset selected from the plurality of assets;
determine whether the identifier for the asset associated with the identification marking is in the database; and
alert a user when the identifier is missing from the database.

17. The non-transitory machine-readable storage medium of claim 16, wherein the instructions direct the processor to detect a radio-frequency identification signal.

18. The non-transitory machine-readable storage medium of claim 16, wherein the instructions direct the processor to transmit an alert to an external device.

19. The non-transitory machine-readable storage medium of claim 16, wherein the instructions direct the processor to receive updates to the database from a scanner transmit an alert to an external device.

20. The non-transitory machine-readable storage medium of claim 16, wherein the instructions direct the processor to operate a tagging unit to re-apply a radio-frequency identification tag to the asset when the identifier is missing.
